(19) United States
(12) Patent Application Publication
(10) Pub. No.: US 2019/0318152 A1
(43) Pub. Date: Oct. 17, 2019

(54) IMAGE ANALYSIS APPARATUS, METHOD, AND PROGRAM

(71) Applicant: OMRON Corporation, Kyoto-shi (JP)

(72) Inventors: Hatsumi AOI, Kyoto-shi (JP); Tomoyoshi AIZAWA, Kyoto-shi (JP)

(73) Assignee: OMRON Corporation, Kyoto-shi (JP)

(21) Appl. No.: 16/299,210

(22) Filed: Mar. 12, 2019

(30) Foreign Application Priority Data
Apr. 12, 2018 (JP) 2018-076730

(51) Int. Cl. G06K 9/00

(52) U.S. Cl. CPC G06K 9/00255; G06K 9/00281; G06K 9/00248; G06K 9/00845

(57) ABSTRACT

In a reference position determination unit, for example, a plurality of feature points of eyes and a nose of a face are detected by rough search from an image area including a driver's face extracted by a face area extractor with a rectangular frame. Based on the feature points of the respective organs, a position between eyebrows of the driver's face is detected, and this is determined as a reference position of the face. Then, a face area re-extractor corrects the position of the rectangular frame with respect to image data so that the determined reference position of the face is the center of the rectangular frame, and an image area including the face is re-extracted from the image data by using the rectangular frame in the corrected position.

### CROSS-REFERENCE TO RELATED APPLICATION

This application is based on Japanese Patent Application No. 2018-076730 filed with the Japan Patent Office on Apr. 12, 2018, the entire contents of which are incorporated herein by reference.

### FIELD

The disclosure relates to an image analysis apparatus, a method, and a program used for detecting an object to be detected such as a human face, for example, from a captured image.

### BACKGROUND

For example, in the field of monitoring such as driver monitoring, there has been proposed a technique in which a human face is detected from an image captured by a camera, positions of a plurality of organs such as eyes, a nose, and a mouth are detected with respect to the detected face, and based on the detection results, a human face, its orientation, and the like are estimated.

As the method for detecting a human face from a captured image, an image processing technique such as template matching is known. For example, a first method is a method of detecting an image area in which the degree of matching with an image of a template is equal to or greater than a threshold value from the captured image, while moving the position of the template stepwise with respect to the captured image at a predetermined number of pixel intervals, and extracting the detected image area with, for example, a rectangular frame to detect a human face.

Further, for example, a second method is a method of searching a position between eyebrows in a human face using a template prepared in advance for detecting a position between eyebrows, and extracting a target image with a rectangular frame having a predetermined size around the searched position between the eyebrows (e.g., see Japanese Unexamined Patent Publication No. 2004-185611)

However, in the first method, the step interval of the position of the template with respect to the captured image is typically set greater than the pixel interval of the captured image in order to reduce the number of matching times of the template and shorten the time required for detection. For this reason, the positional relationship between the rectangular frame and the human face extracted with the rectangular frame may vary. When variations occur in the position of the human face within the rectangular frame, in the case of estimating positions of organs such as eyes, a nose, a mouth, and a face contour from the extracted human face image, it is conceivable that all the organs necessary for estimation cannot be detected or misdetection occurs, which leads to deterioration in estimation accuracy.

In the second method, since the human face is extracted from the captured image with the position between the eyebrows as the center, variations in positional relationship between the rectangular frame and the human face hardly occurs, and it is possible to stably extract each organ and the like of the face. However, the template matching processing for detecting the position between the eyebrows requires many processing steps and long processing time, whereby a processing load of the apparatus increases and a detection delay tends to occur.

### SUMMARY

One or more aspects have been made in view of the above circumstances, and may provide a technique capable of detecting an object to be detected from image data in short processing time with high accuracy.

In order to solve the above problem, a first aspect of the image analysis apparatus or an image analysis method executed by the image analysis apparatus is to: acquire an image obtained by capturing an image of a range including an object to be detected; extract a partial image of an area in which the object to be detected exists from the acquired image by using an extraction frame of a predetermined size surrounding the partial image; determine a reference position of the object to be detected from the extracted partial image; correct, based on the determined reference position, an extraction position in which the partial image is extracted with the extraction frame and re-extract the partial image with the extraction frame at the corrected extraction position; and detect a state of the object to be detected from the re-extracted partial image.

According to a first aspect, for example, even when variations occur in the extraction position in which the partial image is extracted with the extraction frame, the extraction position is corrected based on the reference position of the object to be detected, and the partial image is re-extracted in accordance with the corrected extraction position. Hence, the influence of variations in the extraction position is reduced, which makes it possible to enhance the detection accuracy at the time of detecting the state of the object to be detected from the partial image. Further, the reference position of the object to be detected is determined based on the partial image extracted in the varied state. Thus, as compared with the case of searching the reference position of the object to be detected from the acquired image, it is possible to shorten and reduce the processing time and processing load required for extracting the partial image.

In a second aspect of the apparatus according to one or more aspects, the image acquisition unit acquires an image obtained by capturing an image of a scene including a human face, and the partial image extractor extracts a partial image of an area in which the human face exists from the acquired image by using an extraction frame of a predetermined size surrounding the partial image. Then, the reference position determination unit detects positions of feature points corresponding to a plurality of organs of the human face from the extracted partial image and determines as the reference position an arbitrary position on a center line of the human face based on the detected positions of the respective feature points, the re-extractor corrects, based on the determined reference position, the extraction position in which the partial image is extracted with the extraction frame so that the reference position of the partial image is a center of the extraction frame, and re-extract the partial image included in the extraction frame at the corrected extraction position, and the state detector detects a state of the human face from the re-extracted partial image.

As an example, the reference position determination unit determines any of the following on the human face as the reference position: a position between eyebrows, a vertex of a nose, a mouth center point, an midpoint of the position between the eyebrows and the nose vertex, an midpoint of the position between the eyebrows and the mouth center point, and an average position of the position between the eyebrows, the nose vertex, and the mouth center point.

According to a second aspect, in the case of detecting the human face and detecting its state as in driver monitoring, even when variations occur in the extraction position of the face image extracted with the extraction frame, the extraction position is corrected taking an arbitrary position on a center line of the face as the reference position, and the face image is re-extracted in accordance with the corrected extraction position. For this reason, the influence of variations in the extraction position is reduced, which makes it possible to detect the state of the face with high accuracy. Further, the detection of an arbitrary position on the center line of the face is determined based on the partial image extracted in the varied state described above. Thus, as compared with the case of searching an arbitrary position on the center line of the face from the acquired image, it is possible to shorten the processing time required for the search and reduce the processing load of the apparatus.

A third aspect of the apparatus is that the reference position determination unit searches a position of a feature point of the object to be detected from the extracted partial image with first search accuracy, and determines a reference position of the object to be detected based on the searched feature point, and the state detector searches a feature point of the object to be detected with second search accuracy higher than the first search accuracy from the re-extracted partial image, and detects a state of the object to be detected based on the searched feature point.

According to a third aspect, the processing of searching the position of the feature point of the object to be detected from the partial image in order to determine the reference position of the object to be detected is performed with low precision search processing, as compared with the processing of searching the feature point of the object to be detected from the partial image in order to determine the state of the object to be detected. It is thereby possible to further shorten and reduce the processing time and the processing load required for searching the feature point for determining the reference position.

A fourth aspect of the apparatus further includes an output unit configured to output information representing the detected state of the object to be detected. According to a fourth aspect, based on the information representing the state of the object to be detected, for example, an external apparatus can grasp the state of the object to be detected and take measures suitable for the state.

That is, according to one or more aspects, it is possible to provide a technique that enables detection of an object to be detected from image data in short processing time with high accuracy.

### BRIEF DESCRIPTION OF THE DRAWINGS

FIG. 1 is a diagram illustrating a view for explaining one application example of an image analysis apparatus according to one or more embodiments;

FIG. 2 is a block diagram illustrating an example of a hardware configuration of an image analysis apparatus according to one or more embodiments;

FIG. 3 is a block diagram illustrating an example of a software configuration of an image analysis apparatus according to one or more embodiments;

FIG. 4 is a flow diagram illustrating an example of a procedure and processing contents of learning processing by an image analysis apparatus, such as in FIG. 3;

FIG. 5 is a flow diagram illustrating an example of a processing procedure and processing contents of image analysis processing by an image analysis apparatus, such as in FIG. 3;

FIG. 6 is a flow diagram illustrating an example of a processing procedure and processing contents of feature point search processing in an image analysis processing, such as in FIG. 5;

FIG. 7 is a diagram illustrating a view for explaining an operation example of a face area extractor of an image analysis apparatus, such as in FIG. 3;

FIG. 8 is a diagram illustrating a view illustrating an example of a face area extracted by a face area extractor of an image analysis apparatus, such as in FIG. 3;

FIG. 9 is a diagram illustrating a view illustrating an example of a reference position determined by a reference position determination unit of an image analysis apparatus, such as in FIG. 3;

FIG. 10 is a diagram illustrating a view illustrating an example of a face area re-extracted by a face area re-extractor of an image analysis apparatus, such as in FIG. 3;

FIG. 11 is a diagram illustrating a view illustrating an example of feature points extracted from a face image; and

FIG. 12 is a diagram illustrating an example in which feature points extracted from a face image are three-dimensionally displayed.

### DETAILED DESCRIPTION

Embodiments will be described below with reference to the drawings.

### Application Example

First, an application example of the image analysis apparatus according to one or more embodiments will be described.

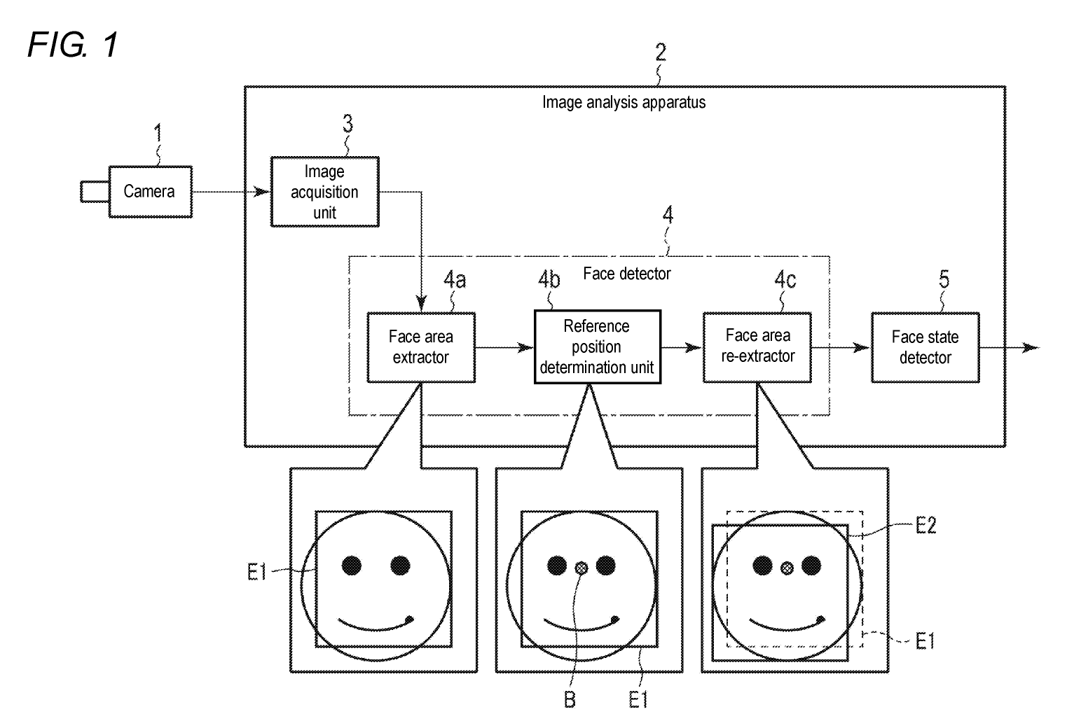

The image analysis apparatus according to one or more embodiments is used, for example, in a driver monitoring apparatus that monitors the state of a driver's face (e.g., the face orientation), and is configured as in FIG. 1, for example.

The image analysis apparatus 2 is connected to a camera 1 and includes an image acquisition unit 3 that acquires an image signal output from the camera 1, a face detector 4, and a face state detector 5. For example, the camera 1 is installed at a position facing the driver's seat, captures an image of a predetermined scene including the face of the driver seated in the driver's seat in a constant frame period, and outputs the image signal.

For example, the image acquisition unit 3 sequentially receives the image signals output from the camera 1, transforms the received image signals into image data made up of digital signals for each frame, and stores the image data into the image memory.

The face detector 4 includes a face area extractor 4a, a reference position determination unit 4b, and a face area re-extractor 4c. The face area extractor 4a reads the image data acquired by the image acquisition unit 3 from the image memory for each frame and extracts an image area (partial image) including the driver's face from the image data. For example, the face area extractor 4a adopts a template matching method, and while moving the position of a reference template stepwise with respect to the image data at a predetermined number of pixel intervals, the face area extractor 4a detects an image area in which a degree of matching with the image of the reference template from the image data is equal to or greater than a threshold value, and extracts the detected image area with a rectangular frame.

From the image area including the face extracted with the rectangular frame, the reference position determination unit 4b detects feature points of predetermined organs of the face, such as eyes and a nose, by rough search. Then, for example, a position between eyebrows of the face is detected based on the detected positions of the feature points of the respective organs, and the position between the eyebrows is determined as a reference position of the face.

In the rough search, for example, a three-dimensional face shape model with a small dimension number of feature point arrangement vectors is used by limiting the number of feature points to be detected to a small number, such as only the eyes and the nose. Then, by projecting the three-dimensional face shape model for rough search onto the image area of the face extracted with the rectangular frame, a feature amount of each of the organs is acquired from the face image area. A schematic position of each of the limited feature points in the face image area is estimated based on an error amount with respect to a correct value of the acquired feature points and the three-dimensional face shape model at the time when the error amount is within the threshold value.

A face area re-extractor 4c corrects the position of the rectangular frame with respect to the image data based on the reference position determined by the reference position determination unit 4b. For example, the face area re-extractor 4c corrects the position of the rectangular frame with respect to the image data so that the position between the eyebrows detected by the reference position determination unit 4b is the lateral center of the rectangular frame. Then, from the image data, the image area included in the rectangular frame, the position of which has been adjusted, is re-extracted.

For example, the face state detector 5 detects, by detailed search, positions of a plurality of organs of the driver's face, such as the eyes, nose, and mouth, the face contour, and the face orientation from the image area including the face re-extracted by the face area re-extractor 4c. Then, information representing the detected positions of the respective organs of the face and the face orientation is outputted as information representing the state of the driver's face.

For the detailed search, for example, many feature points to be detected are set for the eyes, nose, mouth, cheekbones, and the like, and a three-dimensional face shape model with a large dimension number of feature point arrangement vectors is used. Then, by projecting the three-dimensional face shape model for detailed search onto the image area of the face re-extracted with the rectangular frame, the feature amount of each of the organs is acquired from the face image area. The position of the large number of feature points in the face image area are estimated based on the error amount with respect to the correct value of the acquired feature amount and the three-dimensional face shape model at the time when the error amount is within the threshold value.

Due to the configuration as described above, in the image analysis apparatus 2, first, for example by the template matching method, the face area extractor 4a extracts the image area including the driver's face from the image data, acquired by the image acquisition unit 3, by using a rectangular frame E1. At this time, the step interval of the template is often set to a rough interval equivalent to a plurality of pixels, for example. Therefore, due to the step interval, variations may occur in the extraction position of the image area including the face extracted with the rectangular frame E1. Depending on the magnitude of the variations, for example, as illustrated in FIG. 1, some organs of the face may not be included in the rectangular frame E1.

However, in the image analysis apparatus 2, the reference position determination unit 4b detects feature points of a plurality of organs (e.g., eyes and a nose) of the face by rough search from the image area including the face extracted with the rectangular frame E1, and detects a position B between the eyebrows, for example as illustrated in FIG. 1, based on the detected feature points of the respective organ. Then, the face area re-extractor 4c corrects the position of the rectangular frame E1 with the determined position B between the eyebrows as the reference position of the face. For example, the position of the rectangular frame E1 with respect to the image data is corrected so that the position B between the eyebrows is the lateral center of the rectangular frame. Then, the image area including the face is re-extracted from the image data by using the rectangular frame in the corrected position. E2 in FIG. 1 denotes an example of the position of the corrected rectangular frame.

Next, in the image analysis apparatus 2, the face state detector 5 detects the positions of the eyes, nose, and mouth of the driver's face, the face contour, and the like, and detects the face orientation, from the re-extracted image area including the face. Information representing the detected positions of the organs of the face and the face orientation is output as information representing the state of the driver's face.

Therefore, in one or more embodiments, variations occur in the extraction position of the image area including the face extracted with the rectangular frame, and even when some organs of the face are not included in the rectangular frame due to the variations, the reference position is determined based on the position of the organ of the face included in the image area extracted then. Based on the reference position, the position of the rectangular frame with respect to the image data is corrected, and the image area including the face is re-extracted. Hence, in the image area extracted with the rectangular frame, the organs of the face necessary for detecting the face orientation and the like can be all contained, and the state of the face such as the face orientation can be detected with high accuracy. In addition, the rough search is used to detect the organs of the face necessary for determining the reference position. Therefore, the reference position can be determined in a short time with a small image processing amount as compared with the case of directly searching the reference position of the face from the captured image data.

### First Embodiment

### Configuration Example

(1) System

An image analysis apparatus according to one or more embodiments is used, for example, in a driver monitoring system for monitoring the state of a face of a driver. In this example, the driver monitoring system includes a camera 1 and an image analysis apparatus 2.

The camera 1 is disposed, for example, at a position of the dashboard facing the driver. The camera 1 uses, for example, a complementary metal-oxide-semiconductor (CMOS) image sensor capable of receiving near infrared light as an imaging device. The camera 1 captures an image of a predetermined scene including the driver's face and transmits an image signal of the captured image to the image analysis apparatus 2 via, for example, a signal cable. As the imaging device, another solid-state imaging device such as a charge coupled device (CCD) may be used. Further, the installation position of the camera 1 may be set anywhere as long as being a place facing the driver, such as a windshield or a room mirror.

(2) Image Analysis Apparatus

The image analysis apparatus 2 detects the face image area of the driver from the image signal obtained by the camera 1 and detects the state of the driver's face, for example, the face orientation, based on the face image area.

(2-1) Hardware Configuration

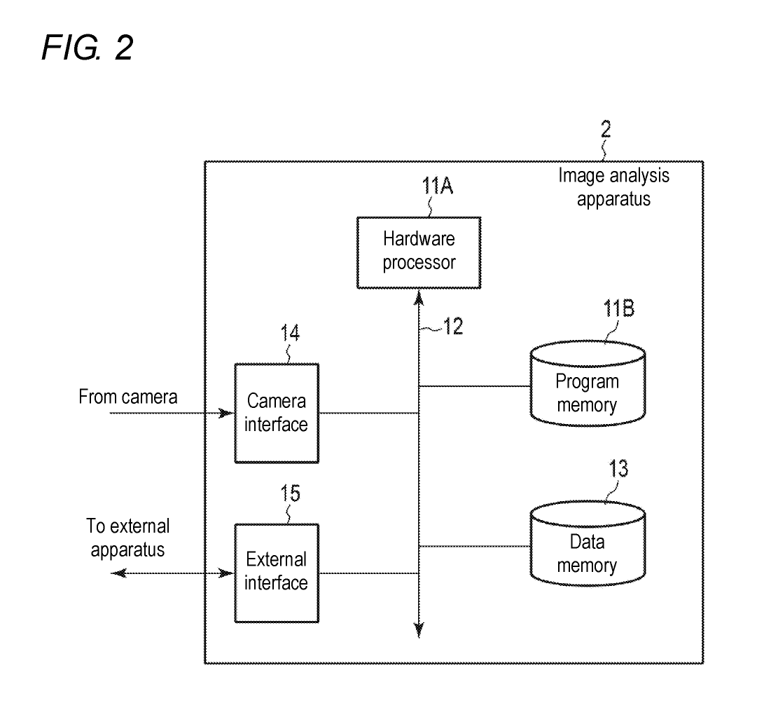

FIG. 2 is a block diagram illustrating an example of a hardware configuration of the image analysis apparatus 2.

The image analysis apparatus 2 has a hardware processor 11A such as a central processing unit (CPU). A program memory 11B, a data memory 13, a camera interface 14, and an external interface 15 are connected to the hardware processor 11A via a bus 12.

The camera interface 14 receives an image signal output from the camera 1 via a signal cable. The external interface 15 outputs information representing the detection result of the state of the face to an external apparatus such as a driver state determination apparatus that determines inattentiveness or drowsiness, an automatic driving control apparatus that controls the operation of the vehicle, and the like.

When an in-vehicle wired network such as a local area network (LAN) and an in-vehicle wireless network adopting a low power wireless data communication standard such as Bluetooth (registered trademark) are provided in the vehicle, signal transmission between the camera 1 and the camera interface 14 and between the external interface 15 and the external apparatus may be performed using the network.

The program memory 11B uses, for example, a nonvolatile memory such as a hard disk drive (HDD) or a solid state drive (SSD) that can be written and read as needed and a nonvolatile memory such as a read-only memory (ROM) as storage mediums, and stores programs necessary for executing various kinds of control processing according to one or more embodiments.

The data memory 13 includes, for example, a combination of a nonvolatile memory such as an HDD or an SSD that can be written and read as needed and a volatile memory such as a read-access memory (RAM) as a storage medium. The data memory 13 is used to store various pieces of data acquired, detected, and calculated in the course of executing various kinds of processing according to one or more embodiments, template data, and other data.

(2-2) Software Configuration

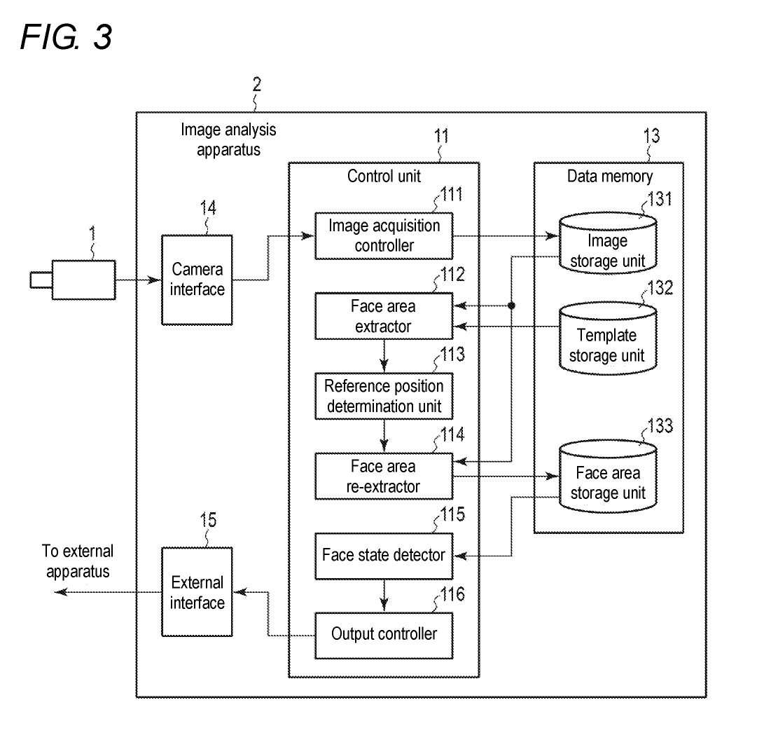

FIG. 3 is a block diagram illustrating a software configuration of the image analysis apparatus 2 according to one or more embodiments.

In a storage area of the data memory 13, an image storage unit 131, a template storage unit 132, and a face area storage unit 133 are provided. The image storage unit 131 is used to temporarily store image data acquired from the camera 1. The template storage unit 132 stores a reference template for extracting an image area showing a face from the image data, and respective three-dimensional face shape models for rough search and detailed search for extracting a position of a predetermined organ of the face from the extracted image area of the face. The face area storage unit 133 is used to temporarily store the image area of the face re-extracted from the image data.

A controller 11 is made up of the hardware processor 11A and the program memory 11B. As processing function units by software, the controller 11 includes an image acquisition controller 111, a face area extractor 112, a reference position determination unit 113, a face area re-extractor 114, a face state detector 115, and an output controller 116. These processing function units are all realized by causing the hardware processor 11A to execute the program stored in the program memory 11B.

The image signal output from the camera 1 is received by the camera interface 14 for each frame and is transformed into image data made up of a digital signal. The image acquisition controller 111 performs processing of taking thereinto the image data for each frame from the camera interface 14 and storing the image data into the image storage unit 131 of the data memory 13.

The face area extractor 112 reads the image data from the image storage unit 131 for each frame and uses the reference template of the face stored in the template storage unit 132 to extract an image area showing the driver's face from the read image data. For example, the face area extractor 112 moves the reference template stepwise at a plurality of preset pixel intervals (e.g., 8 pixels) with respect to the image data, and calculates a luminance correlation value between the reference template and the image data for each position to which the reference template has moved. Then, the calculated correlation value is compared with a preset threshold value, and the image area corresponding to the step position with the calculated correlation value equal to or greater than the threshold value is extracted as the face area showing the driver's face by the rectangular frame. The size of the rectangular frame is preset in accordance with the size of the driver's face shown in the captured image.

As the reference template image of the face, for example, a reference template corresponding to the contour of the entire face and a template based on each organ (the eyes, nose, mouth, etc.) of the face can be used. As a method of extracting a face by template matching, for example, there can be used of a method of detecting a vertex of a head or the like by chromakey processing and detecting a face based on the vertex, a method of detecting an area close to a skin color and detecting the area as a face, or other methods. Further, the face area extractor 112 may be configured to perform learning with a teacher signal through a neural network and detect an area that looks like a face as a face. In addition, the face detection processing by the face area extractor 112 may be realized by applying any existing technology.

For example, from the image area (partial image data) extracted by the face area extractor 112 with a rectangular frame, the reference position determination unit 113 detects feature points of predetermined organs such as the eyes and the nose of driver's face by using a three-dimensional face shape model for rough search stored in the template storage unit 132.

In the rough search, for example, the feature points to be detected are limited only to the eyes and the nose or only to the eyes, for example, and a three-dimensional face shape model with a small dimension number of the feature point arrangement vector is used. The three-dimensional face shape model for rough search is generated by learning processing, for example, in accordance with the actual driver's face. In the three-dimensional face shape model for rough search, a model in which an average initial parameter acquired from a general face image is set may be used.

In the rough search, the three-dimensional face shape model for rough search is projected onto the face image area extracted with the rectangular frame in the face area extractor 112, and sampling is performed based on the three-dimensional face shape model and a sampling feature amount is acquired from the face image area. An error between the acquired sampling feature amount and the correct model parameter is calculated, and a model parameter at the time when the error is equal to or smaller than the threshold value is output as an estimation result of the sampling feature point. In the rough search, the threshold value is set to a value greater than that in the case of the detailed search, namely a value in which an allowable error amount is set large.

As the three-dimensional face shape model for rough search, for example, there may be used such a shape in which a predetermined node of the face shape model is placed at a predetermined position from an arbitrary vertex (e.g., the upper left corner) of the rectangular frame used in the face area extractor 112.

The reference position determination unit 113 determines a reference point of the driver's face based on the position of the feature point in accordance with the predetermined organ of the driver's face detected by rough search. For example, the reference position determination unit 113 estimates the position between the eyebrows based on the positions of the feature points of both eyes and the positions of the feature points of the nose on the driver's face. Then, the position between the eyebrows is determined as the reference position of the driver's face.

The face area re-extractor 114 corrects the position of the rectangular frame with respect to the image data based on the reference position determined by the reference position determination unit 113. For example, the face area re-extractor 114 corrects the position of the rectangular frame with respect to the image data so that the position between the eyebrows detected by the reference position determination unit 113 is the lateral center of the rectangular frame. Then, the face area re-extractor 114 re-extracts the image area surrounded by the rectangular frame in the corrected position, from the image data.

For example, from the image area of the face re-extracted by the face area re-extractor 114, the face state detector 115 detects the positions of feature points of a plurality of organs such as the eyes, nose, and mouth of the driver's face by using a three-dimensional face shape model for detailed search. The detailed search is used for the detection processing here.

In the detailed search, for example, many feature points corresponding to the eyes, nose, mouth, cheekbones, and the like are set as objects to be detected and a three-dimensional face shape model with a large dimension number of feature point arrangement vectors is used. As the three-dimensional face shape model for detailed search, a plurality of models corresponding to a plurality of orientations of the driver's face are prepared. For example, there are prepared models corresponding to representative orientations of the face, such as the front direction, the diagonally right direction, the diagonally left direction, the diagonally upward direction, and the diagonally downward direction of the face. Note that the face orientation may be defined in each of two axial directions of the horizontal direction and the vertical direction at intervals of a constant angle, and a three-dimensional face shape model corresponding to the combination of all the angles of these respective axes may be prepared.

Furthermore, in one or more embodiments, since the rectangular frame is used for extraction of the face image area, the three-dimensional face shape model may be set in such a shape where each of the feature points of the objects to be detected are placed at a predetermined position from an arbitrary vertex (e.g., upper left corner) of the rectangular frame.

In the detailed search, for example, a three-dimensional face shape model for detailed search is projected onto a face image area re-extracted with the rectangular frame in the face area re-extractor 114, sampling based on a retina structure is performed, and a sampling feature amount is acquired from the face image area. The retina structure is a structure of sampling points radially and discretely arranged around a certain feature point (node) of interest.

The detailed search calculates an error amount between the acquired sampling feature amount and the correct model parameter and outputs a model parameter at the time when the error amount is equal to or smaller than the threshold value as the estimation result of the sampling feature point. In the detailed search, as the threshold value, a value set so that the allowable error amount is small is used.

The face state detector 115 estimates the face orientation based on the estimated position of each feature point of the face detected above, and stores information representing the estimated position of each of the feature points and the face orientation into the face area storage unit 133 as information representing the state of the face.

The output controller 116 reads information representing the estimated position of each node of the face and the face orientation detected above from the face area storage unit 133. The output controller 116 then outputs the read information representing the position of each node of the face and the face orientation from the external interface 15 to an apparatus for determining the state of the driver such as dozing or inattentiveness, an automatic driving control apparatus for switching a driving mode of the vehicle between manual and automatic, and the like.

### Operation Example

Next, an operation example of the image analysis apparatus 2 configured as described above will be described.

In this example, it is assumed that the reference template of the face used for the processing of detecting the image area including the face from the captured image data is previously stored in the template storage unit 132.

(1) Learning Processing

First, learning processing required for operating the image analysis apparatus 2 will be described. This learning processing needs to be performed in advance in order to detect the position of the feature point from the image data by the image analysis apparatus 2.

The learning processing is executed by a learning processing program (not illustrated) installed in the image analysis apparatus 2 in advance. Note that the learning processing may be executed by an information processing apparatus such as a server provided on a network other than the image analysis apparatus 2, and the learning result may be downloaded to the image analysis apparatus 2 via the network and stored into the template storage unit 132.

The learning processing includes, for example, processing of acquiring a three-dimensional face shape model, processing of projecting a three-dimensional face shape model onto an image plane, feature amount sampling processing, and processing of acquiring an error estimation matrix.

In the learning processing, a plurality of learning face images (hereinafter referred to as “face images” in the description of the learning processing) and three-dimensional coordinates of the feature points in each face image are prepared. The feature points can be acquired by a technique such as a laser scanner or a stereo camera, but any other technique may be used. In order to enhance the accuracy of the learning processing, this feature point extraction processing is preferably performed on a human face.

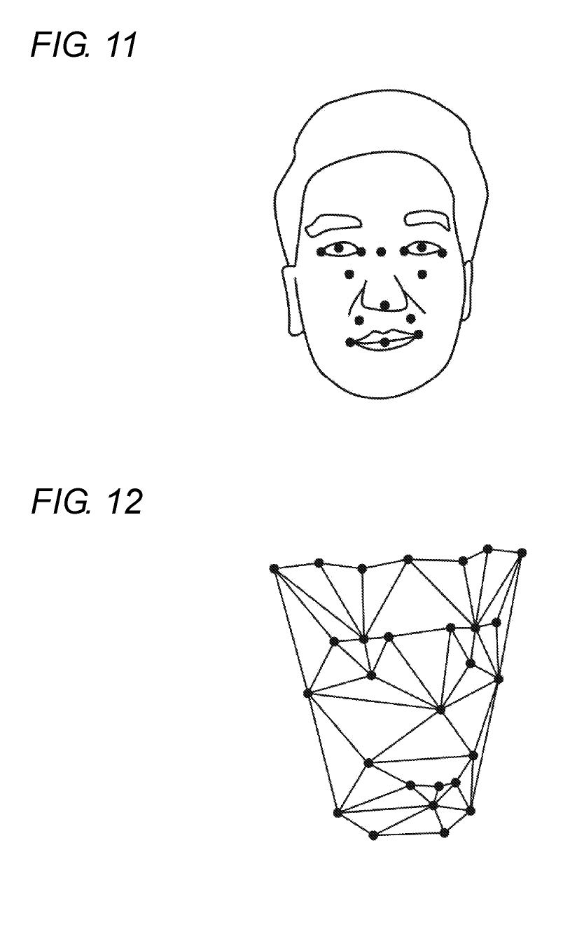

FIG. 11 is a view exemplifying positions of feature points (nodes) as objects to be detected of a face on a two-dimensional plane, and FIG. 12 is a diagram illustrating the above feature point as three-dimensional coordinates. In the examples of FIGS. 11 and 12, the case is illustrated where both ends (the inner corner and the outer corner of the eye) of and the center of the eyes, the right and left cheek portions (the orbital bottom portions), the vertex and the right and left end points of the nose, the right and left mouth corners, the center of the mouth, and the midpoints of the right and left points of the nose and the right and left mouth corners are set as feature points.

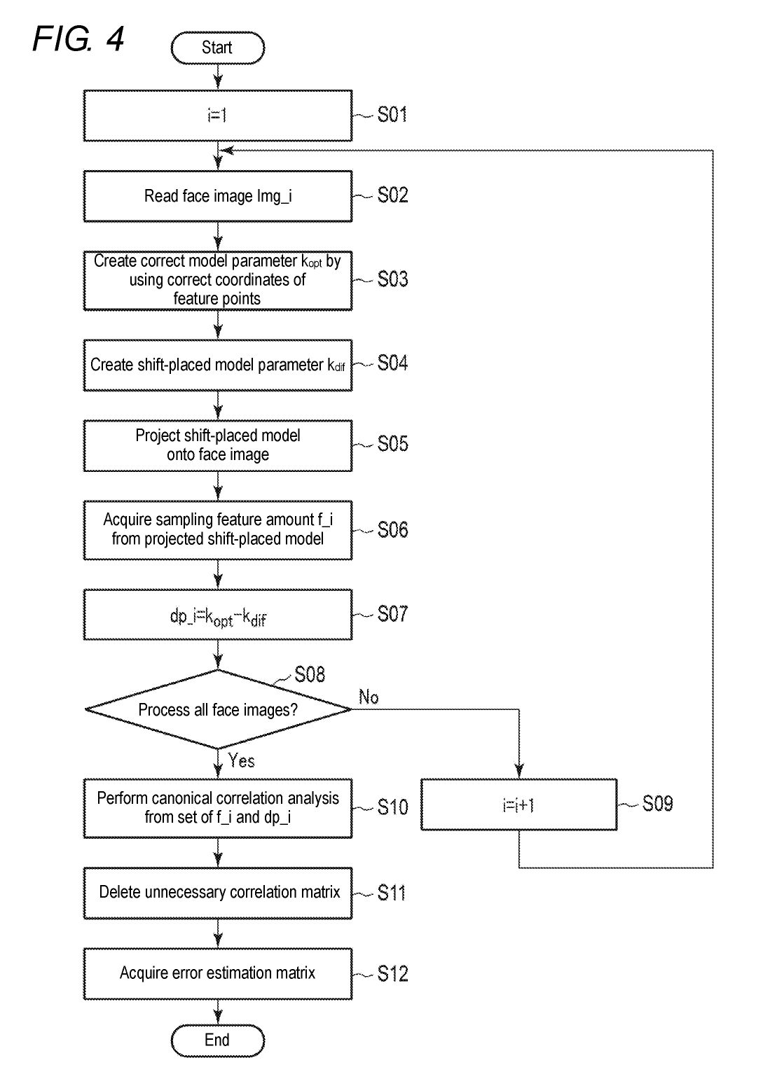

FIG. 4 is a flowchart illustrating an example of the processing procedure and processing contents of the learning processing executed by the image analysis apparatus 2.

(1-1) Acquisition of Three-Dimensional Face Shape Model

First, in step S01, the image analysis apparatus 2 defines a variable i and substitutes 1 for this variable i. Next, in step S02, among the learning face images for which the three-dimensional positions of the feature points have been acquired in advance, an ith face image (Img_i) is read from the image storage unit 131. With 1 being substituted in i, the first face image (Img-1) is read. Subsequently, in step S03, a set of correct coordinates of the feature points of the face image Img_i is read, a correct model parameter kopt is acquired, and a correct model of the three-dimensional face shape model is created. Next, in step S04, the image analysis apparatus 2 creates a shift-placed model parameter kdif based on the correct model parameter kopt, and creates a shift-placed model. This shift-placed model is preferably created by generating a random number and making a shift from the correct model within a predetermined range.

The above processing will be specifically described. First, the coordinates of each feature point pi are denoted as pi(xi, yi, zi). At this time, i indicates a value from 1 to n (n indicates the number of the feature point). Next, a feature point arrangement vector X for each face image is defined as in [Formula 1]. The feature point arrangement vector for a face image j is denoted as Xj. The dimension number of X is 3n.

X=[x₁,y₁,z₁,x₂,y₂,z₂, . . . xₙ,yₙ,zₙ]^{T} [Formula 1]

Meanwhile, in one or more embodiments, a three-dimensional face shape model for rough search and a three-dimensional face shape model for detailed search are necessary. Of these models, the three-dimensional face shape model for rough search is used for searching a limited small number of feature points relating to the eyes and nose, for example, so that the dimension number X of the feature point arrangement vector X corresponds to the above small number of feature points.

On the other hand, for example as exemplified in FIGS. 11 and 12, the three-dimensional face shape model for detailed search is used to search many feature points relating to the eyes, nose, mouth, and cheekbones, so that the dimension number X of the feature point arrangement vector X corresponds to the above large number of feature points.

Next, the image analysis apparatus 2 normalizes all the acquired feature point arrangement vectors X based on an appropriate reference. A designer may appropriately determine the reference of normalization at this time. A specific example of normalization will be described below. For example, when gravity center coordinates of points p1 to pn with respect to a feature point arrangement vector Xj for a certain face image j is indicated by pG, after each point is moved to the coordinate system having the gravity center pG as the origin, the size can be normalized using Lm defined by [Formula 2]. Specifically, the size can be normalized by dividing the moved coordinate value by Lm. Here, Lm is an average value of a linear distances from the gravity center to each point.

$$Lm = \frac{1}{n} {\sum }_{i = 1}^{n} \sqrt{{( {x}_{i} - {x}_{G} )}^{2} + {( {y}_{i} - {y}_{G} )}^{2} + {( {z}_{i} - {z}_{G} )}^{2}} \qquad [ Formula 2 ]$$

Further, rotation can be normalized by, for example, performing rotational transformation on the feature point coordinates so that a straight line connecting the centers of the eyes extends a certain direction. Since the above processing can be expressed by a combination of rotation and enlargement/reduction, the feature point arrangement vector x after normalization can be expressed as in [Formula 3] (similarity transformation).

$$x = {sR}_{x} {R}_{y} {R}_{z} X + t \\ ( \begin{matrix}{R}_{x} = [ \begin{matrix}1 & 0 & 0 \\ 0 & cos θ & - sin θ \\ 0 & sin θ & cos θ\end{matrix} ] , {R}_{y} = [ \begin{matrix}cos φ & 0 & sin φ \\ 0 & 1 & 0 \\ - sin φ & 0 & cos φ\end{matrix} ] , {R}_{z} = [ \begin{matrix}cos ψ & - sin ψ & 0 \\ sin ψ & cos ψ & 0 \\ 0 & 0 & 1\end{matrix} ] \\ t = [ \begin{matrix}{t}_{x} \\ {t}_{y} \\ {t}_{z}\end{matrix} ] \end{matrix} ) \qquad [ Formula 3 ]$$

Next, the image analysis apparatus 2 performs principal component analysis on the set of the normalized feature point arrangement vectors. The principal component analysis can be performed, for example, as follows. First, according to an equation expressed in [Formula 4], a mean vector (a mean vector is indicated by putting down a horizontal line above x) is acquired. In Formula 4, N represents the number of face images, that is, the number of feature point arrangement vectors.

$$\overline{x} = \frac{1}{N} {\sum }_{j = 1}^{N} {x}_{j} \qquad [ Formula 4 ]$$

Then, as expressed in [Formula 5], a difference vector x′ is obtained by subtracting the mean vector from all the normalized feature point arrangement vectors. The difference vector for image j is denoted as x′j.

x′ⱼ=xⱼ−x̅ [Formula 5]

As a result of the above principal component analysis, 3n pairs of eigenvectors and eigenvalues are obtained. An arbitrary normalized feature point arrangement vector can be expressed by an equation in [Formula 6].

x=x̅+Pb [Formula 6]

where P denotes an eigenvector matrix, and b denotes a shape parameter vector. The respective values are as expressed in [Formula 7]. In addition, ei denotes an eigenvector.

P=[e₁,e₂, . . . ,e₃ₙ]^{T}

b=[b₁,b₂, . . . ,b₃ₙ] [Formula 7]

In practice, by using a value up to high-order k dimensions with large eigenvalues, an arbitrary normalized feature point arrangement vector x can be expressed by approximation as in [Formula 8]. Hereinafter, ei is referred to as an ith principal component in descending order of eigenvalues.

x=x̅+P′b′

P′=[e₁,e₂, . . . ,eₖ]^{T}

b′=[b₁,b₂, . . . ,b₅] [Formula 8]

At the time of fitting the face shape model to an actual face image, similarity transformation (translation, rotation) is performed on the normalized feature point arrangement vector x. When parameters of similarity transformation are sx, sy, sz, sθ, sφ, sψ, the model parameter k can be expressed as in [Formula 9] together with the shape parameter.

k=└sₓ,s_{y},s_{z},s_{θ},s_{ϕ},s_{ψ},b₁,b₂, . . . ,bₖ┘ [Formula 9]

When the three-dimensional face shape model expressed by this model parameter k substantially exactly matches the feature point position on a certain face image, the parameter is referred to as a three-dimensional correct model parameter in the face image. The exact matching is determined based on a threshold value and criteria set by the designer.

(1-2) Projection Processing

In step S05, the image analysis apparatus 2 projects the shift-placed model onto the learning image.

Projecting the three-dimensional face shape model onto a two-dimensional plane enables the processing to be performed on the two-dimensional image. As a method of projecting the three-dimensional shape onto the two-dimensional plane, various methods exist, such as a parallel projection method and a perspective projection method. Here, a description will be given by taking single point perspective projection as an example among the perspective projection methods. However, the same effect can be obtained using any other method. The single point perspective projection matrix on the z=0 plane is expressed as in [Formula 10].

$$T = [ \begin{matrix}1 & 0 & 0 & 0 \\ 0 & 1 & 0 & 0 \\ 0 & 0 & 0 & r \\ 0 & 0 & 0 & 1\end{matrix} ] \qquad [ Formula 10 ]$$

where r=−1/z, and zc denotes a projection center on the z axis. As a result, the three-dimensional coordinates [x, y, z] are transformed as in [Formula 11] and expressed by the coordinate system on the z=0 plane as in [Formula 12].

$$\begin{matrix}[ x y z 1 ] [ \begin{matrix}1 & 0 & 0 & 0 \\ 0 & 1 & 0 & 0 \\ 0 & 0 & 0 & r \\ 0 & 0 & 0 & 1\end{matrix} ] = [ x y 0 rz + 1 ] & [ Formula 11 ] \\ [ {x}^{*} {y}^{*} ] = [ \frac{x}{rz + 1} \frac{y}{rz + 1} ] & [ Formula 12 ]\end{matrix}$$

By the above processing, the three-dimensional face shape model is projected onto the two-dimensional plane.

(1-3) Feature Amount Sampling

Next, in step S06, the image analysis apparatus 2 executes sampling by using the retina structure based on the two-dimensional face shape model onto which the shift-placed model has been projected, and acquires the sampling feature amount f_i.

Sampling of the feature amount is performed by combining a variable retina structure with the face shape model projected onto the image. The retina structure is a structure of sampling points radially and discretely arranged around a certain feature point (node) of interest. Performing sampling by the retina structure enables efficient low-dimensional sampling of information around the feature point. In this learning processing, sampling is performed by the retina structure at a projection point (each point p) of each node of the face shape model (hereinafter referred to as a two-dimensional face shape model) projected from the three-dimensional face shape model onto the two-dimensional plane. Note that sampling by the retina structure refers to performing sampling at sampling points determined in accordance with the retina structure.

When coordinates of an ith sampling point is qi(xi, yi), the retina structure can be expressed as in [Formula 13].

r=[q₁^{T},q₂^{T}, . . . ,qₘ^{T}]^{T} [Formula 13]

Therefore, for example, a retina feature amount fp obtained by performing sampling by the retina structure for a certain point p(xp, yp) can be expressed as in [Formula 14].

fₚ=[f(p+q₁), . . . ,f(p+qₘ)]^{T} [Formula 14]

where f(p) denotes a feature amount at the point p (sampling point p). Further, the feature amount of each sampling point in the retina structure can be obtained as, for example, a luminance of the image, a Sovel filter feature amount, a Harr Wavelet feature amount, a Gabor Wavelet feature amount, and a combination of these. When the feature amount is multidimensional as in the case of performing the detailed search, the retina feature amount can be expressed as in [Formula 15].

fₚ=[f₁(p+q₁⁽¹⁾), . . . ,f_{D}(p+q₁^{(D)}), . . . ,f₁(p+qₘ⁽¹⁾) . . . ,f_{D}(p+qₘ^{(D)})]^{T} [Formula 15]

where D denotes the dimension number of the feature amount, and fd(p) denotes a d-dimensional feature amount at the point p. qi(d) denotes the ith sampling coordinate of the retina structure with respect to the d-dimensions.

The size of the retina structure can be changed in accordance with the scale of the face shape model. For example, the size of the retina structure can be changed in inverse proportion to a translation parameter sz. At this time, the retina structure r can be expressed as in [Formula 16]. Note that α is an appropriate fixed value. Further, the retina structure may be rotated or changed in shape in accordance with other parameters in the face shape model. The retina structure may be set so that its shape (structure) differs depending on each node of the face shape model. The retina structure may have only one center point structure. That is, a structure in which only a feature point (node) is set as a sampling point is included in the retina structure.

r=αs_{z}⁻¹[q₁^{T},q₂^{T}, . . . ,qₘ^{T}]^{T} [Formula 16]

In the three-dimensional face shape model determined by a certain model parameter, a vector obtained by arranging the retina feature amounts obtained by performing the above sampling for the projection point of each node projected onto the projection plane is referred to as the sampling feature amount f in the three-dimensional face shape model. The sampling feature amount f can be expressed as in [Formula 17]. In [Formula 17], n denotes the number of nodes in the face shape model.

f=[fₚ₁^{T},fₚ₂^{T}, . . . ,fₚₙ^{T}]^{T} [Formula 17]

At the time of sampling, each node is normalized. For example, normalization is performed by performing scale transformation so that the feature amount falls within the range of 0 to 1. In addition, normalization may be performed by performing transformation so as to obtain a certain average or variance. Note that there are cases where it is not necessary to perform normalization depending on the feature amount.

(1-4) Acquisition of Error Estimation Matrix

Next, in step S07, the image analysis apparatus 2 acquires an error (deviation) dp_i of the shape model based on the correct model parameter kopt and the shift-placed model parameter kdif. Here, in step S08, it is determined whether or not the processing has been completed for all learning face images. This determination can be performed by, for example, comparing the value of i with the number of learning face images. When there is an unprocessed face image, the image analysis apparatus 2 increments the value of i in step S09 and executes the processing in step SO2 and the subsequent steps based on the incremented new value of i.

On the other hand, when it is determined that the processing has been completed for all the face images, in step S10, the image analysis apparatus 2 performs canonical correlation analysis on a set of the sampling feature amount f_i obtained for each face image and the difference dp_i from the three-dimensional face shape model obtained for each face image. Then, an unnecessary correlation matrix corresponding to a fixed value smaller than a predetermined threshold value is deleted in step S11, and a final error estimation matrix is obtained in step S12.

The error estimation matrix is acquired by using canonical correlation analysis. The canonical correlation analysis is one of methods for finding the correlation between different variates of two dimensions. By the canonical correlation analysis, when each node of the face shape model is placed at an erroneous position (a position different from the feature point to be detected), it is possible to obtain a learning result on the correlation representing which direction should be corrected is set.

First, the image analysis apparatus 2 creates a three-dimensional face shape model from the three-dimensional position information of the feature points of the learning face image. Alternatively, a three-dimensional face shape model is created from the two-dimensional correct coordinate point of the learning face image. Then, a correct model parameter is created from the three-dimensional face shape model. By shifting this correct model parameter within a certain range by a random number or the like, a shift-placed model is created in which at least one of the nodes shifts from the three-dimensional position of the feature point. Then, a learning result on the correlation is acquired using the sampling feature amount acquired based on the shift-placed model and the difference between the shift-placed model and the correct model as a set. Specific processing will be described below.

In the image analysis apparatus 2, firstly, two sets of variate vectors x and y are defined as in [Formula 18]. x indicates the sampling feature amount with respect to the shift-placed model. y indicates the difference between the correct model parameter (kopt) and the shift-placed model parameter (parameter indicating the shift-placed model: kdif).

x=[x₁,x₂, . . . xₚ]^{T}

y=[y₁,y₂, . . . y_{q}]^{T}=kₒₚₜ−k_{dif} [Formula 18]

Two sets of variate vectors are normalized to average “0” and variance “1” in advance for each dimension. The parameters (the average and variance of each dimension) used for normalization are necessary for the feature point detection processing described later. Hereinafter, the parameters are denoted as xave, xvar, yave, yvar, respectively, and are referred to as normalization parameters.

Next, when a linear transformation for two variates is defined as in [Formula 19], a and b that maximize the correlation between u and v are found.

u=a₁x₁+ . . . +aₚxₚ=a^{T}x

v=b₁y₁+ . . . +b_{q}y_{q}=b^{T}y [Formula 19]

When the simultaneous distribution of x and y are considered and the variance-covariance matrix Σ is defined as in [Formula 20], a and b above are obtained as eigenvectors with respect to the maximum eigenvalues at the time of solving general eigenvalue problems represented in [Formula 21].

$$\begin{matrix}Σ = [ \begin{matrix}{Σ}_{XX} & {Σ}_{XY} \\ {Σ}_{YX} & {Σ}_{YY}\end{matrix} ] & [ Formula 20 ] \\ ( {Σ}_{XY} {Σ}_{YY}^{- 1} {Σ}_{YX} - {λ}^{2} {Σ}_{XX} ) A = 0 \\ ( {Σ}_{YX} {Σ}_{XX}^{- 1} {Σ}_{XY} - {λ}^{2} {Σ}_{YY} ) B = 0 & [ Formula 21 ]\end{matrix}$$

Of the above, the eigenvalue problem with the lower dimension is solved first. For example, when the maximum eigenvalue obtained by solving the first expression is denoted as λ1 and the corresponding eigenvector is denoted as a1, a vector b1 is obtained by an equation expressed in [Formula 22].

$${b}_{1} = \frac{1}{{λ}_{1}} {Σ}_{YY}^{- 1} {Σ}_{YX} {a}_{1} \qquad [ Formula 22 ]$$

λ1 obtained in this way is referred to as a first canonical correlation coefficient. In addition, u1 and v1 expressed by [Formula 23] is referred to as first canonical variates.

u₁=a₁^{T}x

v₁=b₁^{T}y [Formula 23]

Hereinafter, canonical variates are sequentially obtained based on the magnitude of the eigenvalues, such as a second canonical variate corresponding to the second largest eigenvalue and a third canonical variate corresponding to the third largest eigenvalue. A vector used for feature point detection processing to be described later is assumed to be a vector up to a Mth canonical variate with an eigenvalue equal to or greater than a certain value (threshold value). The designer may appropriately determine the threshold value at this time. Hereinafter, transformation vector matrices up to the Mth canonical variate are denoted as A′, B′ and referred to as error estimation matrices. A′, B′ can be expressed as in [Formula 24].

A′=[a₁, . . . ,a_{M}]

B′=[b₁, . . . ,b_{M}] [Formula 24]

B′ is not generally a square matrix. However, since an inverse matrix is required in the feature point detection processing, a pseudo 0 vector is added to B′ and referred to as a square matrix B″. The square matrix B″ can be expressed as in [Formula 25].

B″=[b₁, . . . ,b_{M},0, . . . ,0] [Formula 25]

The error estimation matrix can also be obtained by using analysis methods such as linear regression, linear multiple regression, or nonlinear multiple regression. However, using the canonical correlation analysis makes it possible to ignore the influence of a variate corresponding to a small eigenvalue. It is thus possible to eliminate the influence of elements not having an influence on the error estimation, and more stable error estimation becomes possible. Therefore, unless such an effect is required, it is also possible to acquire an error estimation matrix by using the above-described other analysis method instead of the canonical correlation analysis. The error estimation matrix can also be obtained by a method such as support vector machine (SVM).

In the learning processing described above, only one shift-placed model is created for each learning face image, but a plurality of shift-placed models may be created. This is realized by repeating the processing in steps S03 to S07 on the learning image a plurality of times (e.g., 10 to 100 times). The above-described learning processing is described in detail in Japanese Patent No. 4093273.

(2) Detection of Driver's Face State

Using the three-dimensional face shape model obtained by the above learning processing, the image analysis apparatus 2 executes processing of detecting the state of the driver's face as follows.

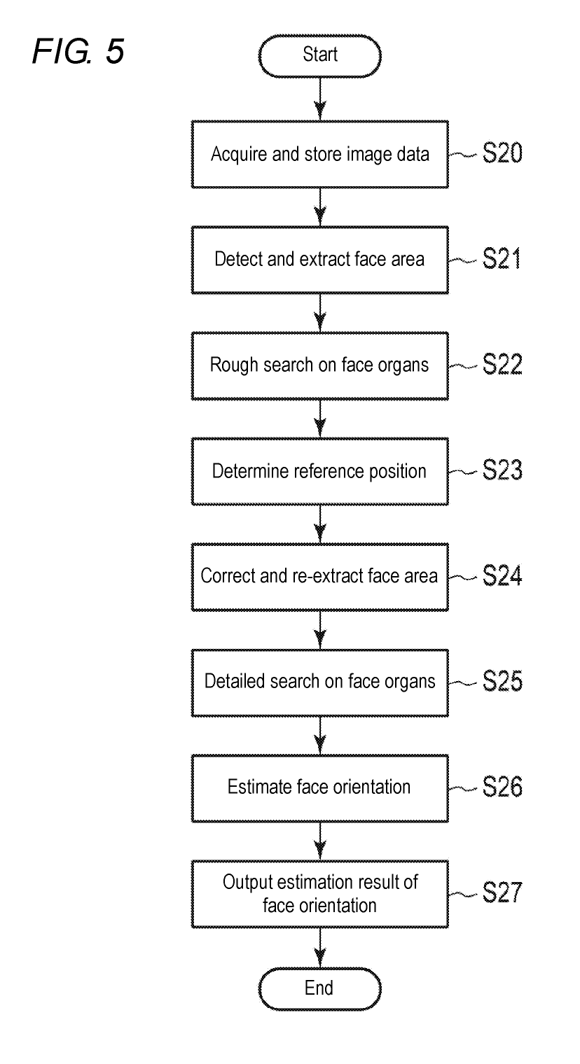

FIG. 5 is a flowchart illustrating an example of a processing procedure and processing contents of the face state detection processing.

(2-1) Acquisition of Image Data Including Driver's Face

For example, an image of the driver in driving is taken from the front by the camera 1, and the image signal obtained by this is sent from the camera 1 to the image analysis apparatus 2. The image analysis apparatus 2 receives the image signal with the camera interface 14 and transforms the image signal into image data made of a digital signal for each frame.

Under control of the image acquisition controller 111, the image analysis apparatus 2 takes thereinto the image data for each frame in step S20 and sequentially stores the image data into the image storage unit 131 of the data memory 13. Note that a frame period of the image data stored into the image storage unit 131 can be set arbitrarily.

(2-2) Extraction of Face Area

Next, under control of the face area extractor 112, the image analysis apparatus 2 reads the image data from the image storage unit 131 for each frame in step S21. The image area showing the driver's face is detected from the read image data by using the reference template of the face stored in advance in the template storage unit 132, and is extracted using a rectangular frame.

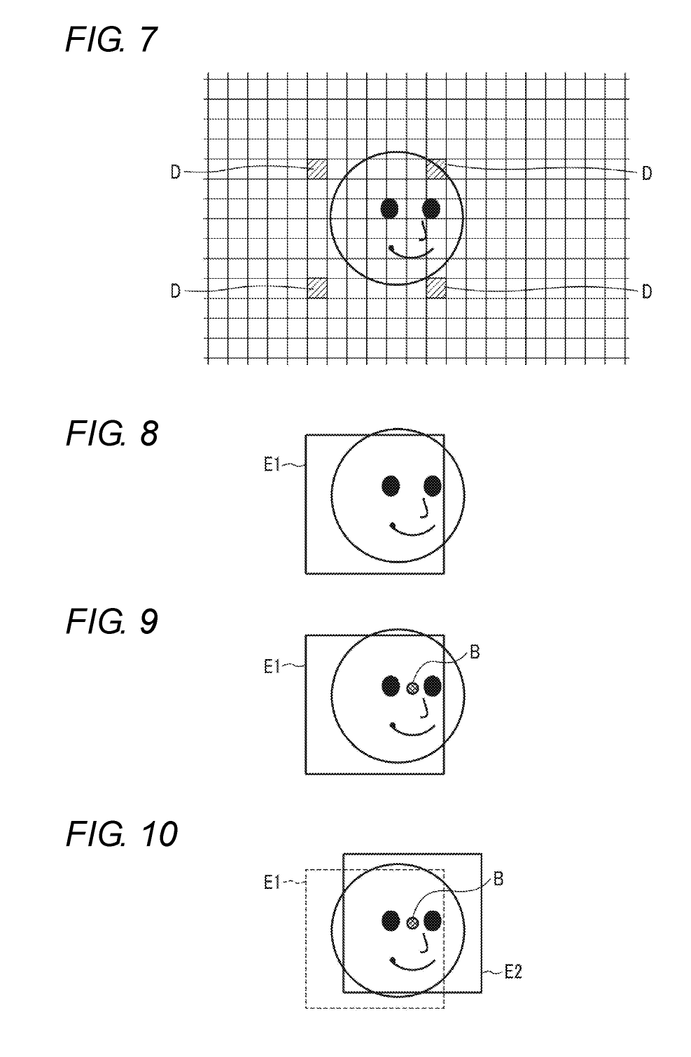

For example, the face area extractor 112 moves the reference template of the face stepwise at preset plurality of pixel intervals (e.g., 8 pixels) with respect to the image data. FIG. 7 is a view illustrating an example thereof, and symbol D in the figure denotes pixels at four corners of the reference template. Each time the reference template of the face is moved by one step, the face area extractor 112 calculates a luminance correlation value between the reference template and the image data, compares the calculated correlation value with a preset threshold value, and detects an area corresponding to a step movement position with a correlation value equal to or greater than the threshold value as the face image area including the face.

That is, in this example, the face image area is detected using a search method having a rough search interval as compared with a search interval in a case where the reference template is moved for each pixel. Then, the face area extractor 112 extracts the detected face image area from the image data by using a rectangular frame and stores the face image area into a face image area storage unit (not illustrated) in the data memory 13. FIG. 8 illustrates an example of the positional relationship between the extracted face image and the rectangular frame E1.

(2-3) Rough Search of Facial Organs

Next, under control of the reference position determination unit 113, first in step S22, the image analysis apparatus 2 detects, from the face image area extracted by the face area extractor 112 with the rectangular frame, a plurality of feature points set for the organs of the driver's face by using the three-dimensional face shape model stored in the template storage unit 132. In this example, rough search is used for detecting the feature points. In the rough search, as described above, a three-dimensional face shape model with a small dimension number of feature point arrangement vectors is used, which limits the feature points to be detected, for example, only to eyes and a nose or only to eyes.

An example of feature point detection processing using the rough search will be described below.

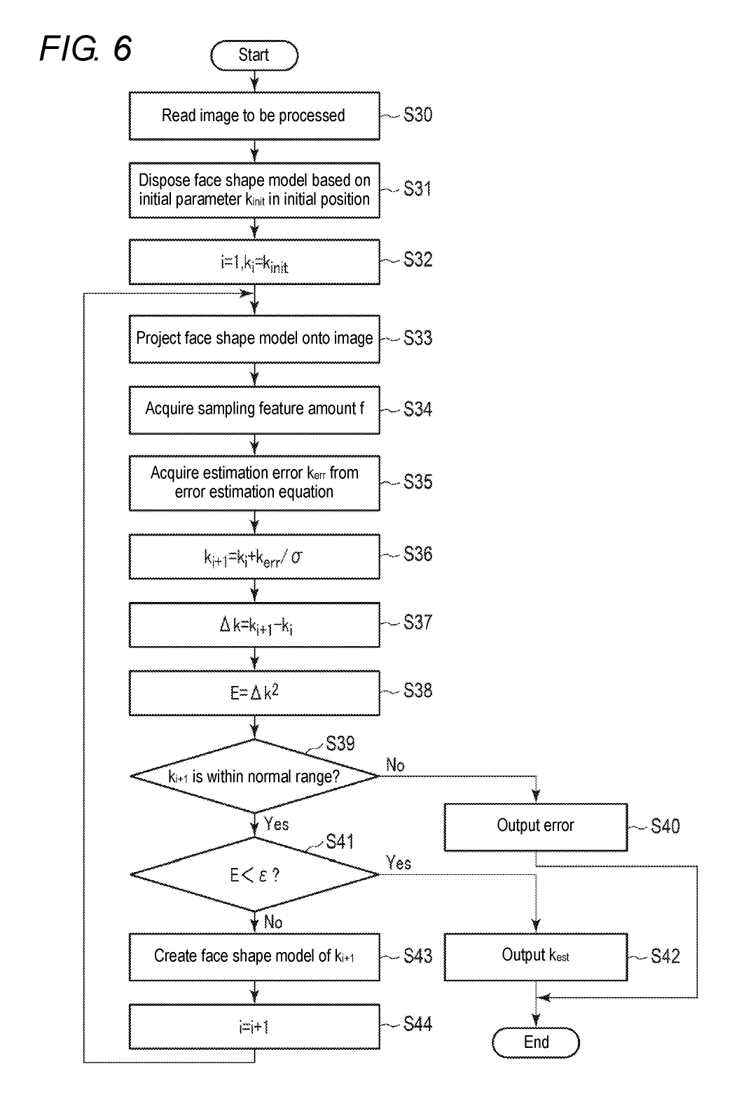

FIG. 6 is a flowchart illustrating an example of the processing procedure and processing contents.

First, in step S30, the reference position determination unit 113 reads a face image area extracted from the image storage unit 131 of the data memory 13 by use of a rectangular frame for each frame of image data. Subsequently, in step S31, a three-dimensional face shape model based on an initial parameter kinit is disposed in the initial position of the face image area. Then, in step S32, a variable i is defined, “1” is substituted into this variable, ki is defined, and the initial parameter kinit is substituted into this.

For example, in the case of acquiring the sampling feature amount for the face image area extracted with the rectangular frame for the first time, the reference position determination unit 113 first determines a three-dimensional position of each feature point in the three-dimensional face shape model and acquires a parameter (initial parameter) kinit of this three-dimensional face shape model. This three-dimensional face shape model is, for example, disposed so as to be formed in a shape where a limited small number of feature points relating to organs (nodes) such as the eyes and nose set in the three-dimensional face shape model for rough search are placed at predetermined positions from an arbitrary vertex (e.g., an upper left corner) of the rectangular frame. Note that that the three-dimensional face shape model may have such a shape where the center of the model and the center of the face image area extracted with the rectangular frame match with each other.

The initial parameter kinit is a model parameter represented by an initial value among the model parameters k expressed by [Formula 9]. An appropriate value may be set for the initial parameter kinit. However, by setting an average value obtained from a general face image to the initial parameter kinit, it is possible to deal with various face orientations, changes in facial expression, and the like. Therefore, for example, for the similarity transformation parameters sx, sy, sz, sθ, sφ, sψ, the average value of the correct model parameters of the face image used in the learning processing may be used. Further, for example, the shape parameter b may be set to zero. When information on the face orientation can be obtained by the face area extractor 112, the initial parameters may be set using this information. Other values empirically obtained by the designer may be used as initial parameters.

Next, in step S33, the reference position determination unit 113 projects the three-dimensional face shape model for rough search represented by ki onto the face image area to be processed. Then, in step S34, sampling based on the retina structure is executed using the projected face shape model to acquire the sampling feature amount f. Subsequently, in step S35, error estimation processing is executed using the sampling feature amount f.

On the other hand, when it is the second time or later to acquire the sampling feature amount for the face image area extracted by the face area extractor 112, the reference position determination unit 113 acquires the sampling feature amount f for the face shape model represented by a new model parameter k obtained by the error estimation processing (i.e., an estimated value ki+1 of the correct model parameter). In this case as well, in step S35, the error estimation processing is executed using the obtained sampling feature amount f.

In the error estimation processing, based on the acquired sampling feature amount f, the error estimation matrix stored in the template storage unit 132, the normalization parameter, and the like, an estimation error kerr between the three-dimensional face shape model ki and the correct model parameter is calculated. Based on the estimation error kerr, the estimated value ki+1 of the correct model parameter is calculated in step S36. Further, Δk is calculated as the difference between ki+1 and ki in step S37, and E is calculated as a square of Δk in step S38.

In addition, in the error estimation processing, the end of the search processing is determined. The processing of estimating the error amount is executed, whereby a new model parameter k is acquired. Hereinafter, a specific processing example of the error estimation processing will be described.

First, using the normalization parameter (xave, xvar), the acquired sampling feature amount f is normalized, and a vector x for performing canonical correlation analysis is obtained. Then, the first to Mth canonical variates are calculated based on an equation expressed in [Formula 26], and thereby a variate u is acquired.

u=[u₁, . . . ,u_{M}]^{T}=A′^{T}x [Formula 26]

Next, a normalized error estimation amount y is calculated using an equation expressed in [Formula 27]. In [Formula 27], when B′ is not a square matrix, B′^{T-1} is a pseudo inverse matrix of B′.

y=B″^{T}^{^{T-1}}u′ [Formula 27]

Subsequently, restoration processing is performed using the normalization parameter (yave, yvar) for the calculated normalized error estimation amount y, thereby acquiring an error estimation amount kerr. The error estimation amount kerr is an error estimation amount from the current face shape model parameter ki to the correct model parameter kopt. Therefore, the estimated value ki+1 of the correct model parameter can be acquired by adding the error estimation amount kerr to the current model parameter ki. However, there is a possibility that kerr contains an error. For this reason, in order to perform more stable detection, an estimated value ki+1 of the correct model parameter is acquired by an equation represented by [Formula 28]. In [Formula 28], σ is an appropriate fixed value and may be appropriately determined by the designer. Further, σ may change in accordance with the change of i, for example.

$${k}_{i + 1} = {k}_{i} + \frac{{k}_{err}}{σ} \qquad [ Formula 28 ]$$

In the error estimation processing, it is preferable to repeatedly perform the sampling processing of the feature amount and the error estimation processing so that the estimated value ki of the correct model parameter approaches the correct parameter. When such repetitive processing is performed, end determination is performed each time an estimated value ki is obtained.

In the end determination, in step S39, it is first determined whether or not the acquired value of ki+1 is within the normal range. As a result of this determination, when the value of ki+1 is not within the normal range, an error is outputted to a display apparatus or the like (not illustrated) in step S40, and the image analysis apparatus 2 ends the search processing.

On the other hand, it is assumed that the value of ki+1 is within the normal range as a result of the determination in step S39. In this case, in step S41, it is determined whether or not the value of E calculated in step S38 exceeds a threshold value ε. If E does not exceed the threshold value ε, it is determined that the processing has converged, and kest is output in step S42. After outputting this kest, the image analysis apparatus 2 ends the face state detection processing based on the one frame image data.

On the other hand, when E exceeds the threshold value ε, processing for creating a new three-dimensional face shape model is performed based on the value of ki+1 in step S43. Thereafter, the value of i is incremented in step S44, and the processing returns to step S33. Then, the image data of the next frame is taken as the processing target image, and a series of processing from step S33 onwards is repeatedly executed based on the new three-dimensional face shape model.

When the value of i exceeds the threshold value, for example, the processing is ended. Further, the processing may be ended also when, for example, the value of Δk expressed by [Formula 29] is equal to or smaller than the threshold value. Moreover, in the error estimation processing, the end determination may be performed based on whether or not the acquired value of ki+1 is within the normal range. For example, when the acquired value of ki+1 does not clearly indicate the correct position in the image of the human face, the processing is ended by outputting an error. Further, even when a part of the node represented by the acquired ki+1 sticks out of the image to be processed, the processing is ended by outputting an error.

Δk=kᵢ₊₁−kᵢ [Formula 29]

In the error estimation processing, when it is determined that the processing is to be continued, the estimated value ki+1 of the acquired correct model parameter is passed to the feature amount sampling processing. On the other hand, when it is determined that the processing is to be ended, the estimated value ki (or may be ki+1) of the correct model parameter obtained at that time is output as the final estimated parameter kest in step S42. Incidentally, the processing for searching feature points of a face described above is described in detail in Japanese Patent No. 4093273.

(2-4) Determination of Reference Position

The reference position determination unit 113 detects the positions of the feature points of the searched facial organs based on the search result of the facial organs by rough search in step S23, and determines the reference position of the face image based on the distance between the detected feature points. For example, the reference position determination unit 113 obtains the distance from the position of the feature point of both eyes of the driver's face and estimates a position between eyebrows based on the position coordinate of the center point of the distance and the position coordinate of the nose feature point. Then, the estimated position between the eyebrows is determined as a reference position B of the driver's face as illustrated in FIG. 9, for example.

(2-5) Re-Extraction of Face Image Area

Next, under control of the face area re-extractor 114, the image analysis apparatus 2 corrects the position of the rectangular frame with respect to the image data based on the reference position determined by the reference position determination unit 113 in step S24. For example, the face area re-extractor 114 corrects the position of the rectangular frame with respect to the image data from E1 to E2 as illustrated in FIG. 10 so that the position between the eyebrows (reference position B) detected by the reference position determination unit 113 is the vertical center and the lateral center of the rectangular frame. Then, the face area re-extractor 114 re-extracts the face image area surrounded by the rectangular frame E2 in the corrected position from the image data.

As a result, even when variations occur in the extraction position of the face image area by the rectangular frame E1, the variations are corrected and a face image including all the main organs of the face necessary for detailed search can be obtained.

(2-6) Detailed Search of Facial Organs

Upon completion of the re-extracting processing of the face image area, the image analysis apparatus 2 proceeds to step S25. Then, under control of the face state detector 115, the positions of many feature points set for a plurality of organs of the driver's face are estimated from the face image area re-extracted by the face area re-extractor 114 by using a three-dimensional face shape model for detailed search.

In the detailed search, as described above, for example, many feature points are set for the eyes, nose, mouth, cheekbones and the like of the face as object to be detected, and the feature points are searched using the three-dimensional face shape model in which the dimension number of the feature point arrangement vector corresponding to these feature points is set. As the three-dimensional face shape model for detailed search, a plurality of models are prepared for a plurality of face orientations of the driver. For example, there are prepared a plurality of kinds of models corresponding to representative orientations of the face, such as the front direction, the diagonally right direction, the diagonally left direction, the diagonally upward direction, and the diagonally downward direction of the face.

Using the plurality of three-dimensional face shape models prepared for the detailed search, the face state detector 115 performs processing of detecting many feature points of the organs to be detected from the face image area re-extracted with the rectangular frame E2. The processing procedure and the processing contents of the detailed search executed here are different in that a three-dimensional face shape model in which the dimension number of the feature point arrangement vector is set greater than that in the case of the rough search is used, that a plurality of prepared three-dimensional face shape models prepared for the face orientation are used, and that the determination threshold value of the estimation error is set to a value smaller than that in the case of the rough search. However, basically, the processing procedure and the processing contents of the detailed search are the same as the processing procedure and processing contents in the case of the rough search described above using FIG. 6.

(2-7) Face Orientation Estimation

Upon completion of the detailed search, next in step S26, under control of the face state detector 115, the image analysis apparatus 2 estimates the orientation of the driver's face based on the search result of the feature points of each organ of the face by the detailed search. For example, it is possible to estimate the face orientation based on the positions of the eyes, nose, and mouth relative to the position of the face contour. In addition, it is possible to estimate the face orientation based on a model having the smallest error amount from the image data among a plurality of three-dimensional face shape models prepared for the face orientation. Then, the face state detector 115 stores, into the face area storage unit 133, the information representing the estimated face orientation and the information representing the positions of the plurality of feature points of the respective organs, as information representing the state of the driver's face.

(2-8) Output of Face State

Under control of the output controller 116, in step S27, the image analysis apparatus 2 reads the information representing the estimated face orientation and the information representing the positions of the plurality of feature points of the respective organs of the face from the face area storage unit 133. Then, the read information is output from the external interface 15 to the external apparatus.

The external apparatus can determine the state of the driver such as inattentive or dozing, for example, based on the face orientation information and the presence or absence of detection of each organ of the face. In addition, at the time of switching the driving mode of the vehicle between manual and automatic, the above information can be used for determining whether to switch.

(Effect)

As described in detail above, in one or more embodiments, in the reference position determination unit 113, for example, a plurality of feature points of the eyes and nose of the face are detected by the rough search from the image area including the driver's face extracted by the face area extractor 112 with the rectangular frame E1, and based on the feature points of the respective organs, the position between the eyebrows of the driver's face is detected, and this is determined as the reference position B of the face. Then, the face area re-extractor 114 corrects the position of the rectangular frame with respect to the image data so that the determined reference position B of the face is the center of the rectangular frame, and re-extracts an image area including a face from the image data by using the rectangular frame in the corrected position.

Thus, variations occur in the extraction position of the image area including the face with the rectangular frame, whereby the position of the rectangular frame with respect to the image data is corrected even when some organs of the face are not included in the rectangular frame, and the image area including the face is re-extracted. Hence in the image area extracted with the rectangular frame, the organ of the face necessary for detecting the face orientation and the like can be all contained, and the state of the face such as the face orientation can be detected with high accuracy. In addition, the rough search is used to detect the organ of the face necessary for determining the reference position. Therefore, the reference position can be determined in a short time with a small image processing amount as compared with the case of directly searching the reference position of the face from the captured image data.

### Modified Examples

In one or more embodiments, only the position of the rectangular frame with respect to the image data has been corrected based on the reference position B of the face detected by rough search. However, the present invention is not limited to this, and the size of the rectangular frame with respect to the image data may be corrected. This can be realized by, for example, trying to detect, from the face image area extracted with a rectangular frame, the right and left contours and the upper and lower contours of the face as one of the feature points of the face by rough search and enlarging the size of the rectangular frame, when an undetected contour is found, in the direction of the undetected contour. Note that determination of the position between the eyebrows of the face as the reference position is the same as in one or more embodiments.

(2) In one or more embodiments, the description has been given taking the example where the case of estimating the positions of a plurality of feature points in accordance with a plurality of organs on the driver's face from the input image data. However, the object to be detected is not limited thereto and may be any object so long as enabling setting of a shape model. For example, the object to be detected may be a whole-human body image, an organ image obtained by a tomographic imaging apparatus such as computed tomography (CT), or the like. In other words, the present technology can be applied to an object having individual differences in size and an object to be detected deformed without changing the basic shape. Further, even in a rigid object to be detected which does not deform like an industrial product such as a vehicle, an electric product, electronic equipment, or a circuit board, the present technology can be applied since a shape model can be set.

(3) In one or more embodiments, the description has been given taking the case as the example where the face state is detected for each frame of the image data, but it is also possible to detect the face state every plural preset frames. In addition, the configuration of the image analysis apparatus, the processing procedure and processing contents of each of the rough search and detailed search of the feature points of the object to be detected, the shape and size of the extraction frame, and the like can be variously modified without departing from the gist of the present invention.

(4) In one or more embodiments, the case has been described as the example where the position between the eyebrows of the human face is detected and determined as the reference position. However, the present invention is not limited to this example, and for example, it is also possible to detect any of positions such as a vertex of a nose, a mouth center point, an midpoint of the position between the eyebrows and the nose vertex, an midpoint of the position between the eyebrows and the mouth center point, and an average position of the position between the eyebrows, the nose vertex, and the mouth center point, and determine the detected position as the reference position. In short, as the reference position, an arbitrary point on the center line of a human face is detected, and this point may be determined as a reference point.

Although one or more embodiments have been described in detail above, the above description is merely an example of the present invention in all respects. It goes without saying that various improvements and modifications can be made without departing from the scope of the present invention. That is, in practicing the present invention, a specific configuration according to one or more embodiments may be adopted as appropriate.

In short, the present invention is not limited to the above embodiments as they are, and structural elements can be modified and embodied in the implementation stage without departing from the gist thereof. In addition, various embodiments can be formed by appropriately combining a plurality of constituent elements disclosed in the above embodiments. For example, some constituent elements may be deleted from all the constituent elements shown in one or more embodiments. Further, constituent elements over different embodiments may be combined as appropriate.

[Appendix]

Part or all of each of the above embodiments may be described as shown in the appended description below in addition to the claims, but it is not limited thereto.

(Appendix 1) An image analysis apparatus including a hardware processor (11A) and a memory (11B), the image analysis apparatus being configured to perform the following by the hardware processor (11A) executing a program stored in the memory (11B): acquiring an image obtained by capturing an image of a scene including an object to be detected (111); extracting a partial image of an area in which the object to be detected exists from the acquired image by using an extraction frame of a predetermined size surrounding the partial image (112); detecting a position of a feature point of the object to be detected from the extracted partial image and determining a reference position of the object to be detected based on the position of the feature point (113); correcting an extraction position in which the partial image is extracted with the extraction frame based on the determined reference position and re-extracting the partial image with the extraction frame at the corrected extraction position (114); and detecting a state of the object to be detected from the re-extracted partial image (115).

(Appendix 2)

An image analysis method executed by an apparatus including a hardware processor (11A) and a memory (11B) storing a program for executing the hardware processor (11A): a step (S20) of acquiring, by the hardware processor (11A), an image obtained by capturing an image of a scene including an object to be detected; a step (S21) of extracting, by the hardware processor (11A), a partial image of an area in which the object to be detected exists from the acquired image by using an extraction frame of a predetermined size surrounding the partial image; a step (S22, S23) of detecting, by the hardware processor (11A), a position of a feature point of the object to be detected from the extracted partial image and determining, by the hardware processor (11A), a reference position of the object to be detected based on the position of the feature point; a step (S24) of correcting, by the hardware processor (11A), an extraction position in which the partial image is extracted with the extraction frame based on the determined reference position and re-extracting, by the hardware processor (11A), the partial image with the extraction frame at the corrected extraction position; and a step (S25) of detecting, by the hardware processor (11A), information representing a feature of the object to be detected from the re-extracted partial image.

1. An image analysis apparatus comprising:
a processor configured with a program to perform operations comprising:
operation as an image acquisition unit configured to acquire an image obtained by capturing an image of a scene comprising an object to be detected;
operation as a partial image extractor configured to extract a partial image of an area in which the object to be detected exists from the acquired image by using an extraction frame of a predetermined size surrounding the partial image;
operation as a reference position determination unit configured to detect a position of a feature point of the object to be detected from the extracted partial image and determine a reference position of the object to be detected based on the position of the feature point;
operation as a re-extractor configured to correct an extraction position in which the partial image is extracted with the extraction frame based on the determined reference position and re-extract the partial image with the extraction frame at the corrected extraction position; and
operation as a state detector configured to detect a state of the object to be detected from the re-extracted partial image.

2. The image analysis apparatus according to claim 1, wherein the processor is configured with the program to perform operations such that
operation as the image acquisition unit comprises operation as the image acquisition unit that acquires an image obtained by capturing an image of a scene comprising a human face,
operation as the partial image extraction comprises operation as the partial image extractor that extracts a partial image of an area in which the human face exists from the acquired image by using an extraction frame of a predetermined size surrounding the partial image,
operation as the reference position determination unit comprises operation as the reference position determination unit that detects positions of feature points corresponding to a plurality of organs of the human face from the extracted partial image and determines, as the reference position, an arbitrary position on a center line of the human face based on the detected positions of the respective feature points,
operation as the re-extractor comprises operation as the re-extractor that corrects the extraction position in which the partial image is extracted with the extraction frame so that the reference position of the partial image is a center of the extraction frame based on the determined reference position, and re-extracts the partial image included in the extraction frame at the corrected extraction position, and
operation as the state detector comprises operation as the state detector that detects a state of the human face from the re-extracted partial image.

3. The image analysis apparatus according to claim 2, wherein the processor is configured with the program to perform operations such that operation as the reference position determination unit comprises operation as the reference position determination unit that determines, on the human face, as the reference position, any of:
a position between eyebrows, a vertex of a nose, a mouth center point, a midpoint of the position between the eyebrows and the nose vertex, a midpoint of the position between the eyebrows and the mouth center point, and an average position of: the position between the eyebrows; the nose vertex; and the mouth center point.

4. The image analysis apparatus according to claim 1, wherein the processor is configured with the program to perform operations such that:
operation as the reference position determination unit comprises operation as the reference position determination unit that searches a position of a feature point of the object to be detected from the extracted partial image with first search accuracy, and determines a reference position of the object to be detected based on the searched feature point, and
operation as the state detector comprises operation as the state detector that searches a feature point of the object to be detected with second search accuracy higher than the first search accuracy from the re-extracted partial image, and detects a state of the object to be detected based on the searched feature point.

5. The image analysis apparatus according to claim 1, wherein the processor is configured with the program to perform operations further comprising operation as an output unit configured to output information representing a state of the object to be detected, detected by the state detector.

6. The image analysis apparatus according to claim 2, wherein the processor is configured with the program such that:
operation as the reference position determination unit comprises operation as the reference position determination unit that searches a position of a feature point of the object to be detected from the extracted partial image with first search accuracy, and determines a reference position of the object to be detected based on the searched feature point, and
operation as the state detector comprises operation as the state detector that searches a feature point of the object to be detected with second search accuracy higher than the first search accuracy from the re-extracted partial image, and detects a state of the object to be detected based on the searched feature point.

7. The image analysis apparatus according to claim 2, wherein the processor is configured with the program to perform operations further comprising operation as an output unit configured to output information representing a state of the object to be detected, detected by the state detector.

8. The image analysis apparatus according to claim 3, wherein the processor is configured with the program such that:
operation as the reference position determination unit comprises operation as the reference position determination unit that searches a position of a feature point of the object to be detected from the extracted partial image with first search accuracy, and determines a reference position of the object to be detected based on the searched feature point, and
operation as the state detector comprises operation as the state detector that searches a feature point of the object to be detected with second search accuracy higher than the first search accuracy from the re-extracted partial image, and detects a state of the object to be detected based on the searched feature point.

9. The image analysis apparatus according to claim 3, wherein the processor is configured with the program to perform operations further comprising operation as an output unit configured to output information representing a state of the object to be detected, detected by the state detector.

10. The image analysis apparatus according to claim 4, wherein the processor is configured with the program to perform operations further comprising operation as an output unit configured to output information representing a state of the object to be detected, detected by the state detector.

11. An image analysis method executed by an image analysis apparatus comprising a hardware processor and a memory, the image analysis method comprising:
acquiring, by the image analysis apparatus, an image obtained by capturing an image of a scene including an object to be detected;
extracting, by the image analysis apparatus, a partial image of an area in which the object to be detected exists from the acquired image by using an extraction frame of a predetermined size surrounding the partial image;
detecting, by the image analysis apparatus, a position of a feature point of the object to be detected from the extracted partial image and determining, by the image analysis apparatus, a reference position of the object to be detected based on the position of the feature point;
correcting, by the image analysis apparatus, an extraction position in which the partial image is extracted with the extraction frame based on the determined reference position and re-extracting, by the image analysis apparatus, the partial image with the extraction frame at the corrected extraction position; and
detecting, by the image analysis apparatus, information representing a feature of the object to be detected from the re-extracted partial image.

12. A non-transitory computer-readable storage medium storing a program, which when read and executed, causes a processor to perform operations comprising the operations of the image analysis apparatus according to claim 1.

13. A non-transitory computer-readable storage medium storing a program, which when read and executed, causes a processor to perform operations comprising the operations of the image analysis apparatus according to claim 2.

14. A non-transitory computer-readable storage medium storing a program, which when read and executed, causes a processor to perform operations comprising the operations of the image analysis apparatus according to claim 3.

15. A non-transitory computer-readable storage medium storing a program, which when read and executed, causes a processor to perform operations comprising the operations of the image analysis apparatus according to claim 4.

16. A non-transitory computer-readable storage medium storing a program, which when read and executed, causes a processor to perform operations comprising the operations of the image analysis apparatus according to claim 5.

17. A non-transitory computer-readable storage medium storing a program, which when read and executed, causes a processor to perform operations comprising the operations of the image analysis apparatus according to claim 6.

18. A non-transitory computer-readable storage medium storing a program, which when read and executed, causes a processor to perform operations comprising the operations of the image analysis apparatus according to claim 7.
